(19) United States
(12) Patent Application Publication
(10) Pub. No.: US 2024/0365870 A1
(43) Pub. Date: Nov. 7, 2024

(54) ELECTROMAGNETIC INDUCTION MEMBER, HEATING DEVICE, AND ELECTRONIC CIGARETTE

(71) Applicant: BYD Precision Manufacture Co., Ltd., Shenzhen (CN)

(72) Inventors: Xiaoyuan ZHENG, Shenzhen (CN); Aiguo ZHANG, Shenzhen (CN); Lixiao ZHAO, Shenzhen (CN); Zuwei CHEN, Shenzhen (CN)

(73) Assignee: BYD Precision Manufacture Co., Ltd., Shenzhen (CN)

(21) Appl. No.: 18/777,761

(22) Filed: Jul. 19, 2024

Related U.S. Application Data
(63) Continuation of application No. PCT/CN2022/139887, filed on Dec. 19, 2022.

(30) Foreign Application Priority Data
Feb. 24, 2022 (CN) 202220401131.0

(51) Int. Cl. A24F 40/465; A24F 40/50

(52) U.S. Cl. CPC A24F 40/465; A24F 40/50

(57) ABSTRACT

An electromagnetic induction member includes a conductive layer and a support frame, and the conductive layer is bonded to the support frame.

### CROSS-REFERENCE TO RELATED APPLICATIONS

The present application is a Continuation Application of International Application No. PCT/CN2022/139887 field on Dec. 19, 2022, which claims priority to and benefits of Chinese Patent Application No. 202220401131.0, filed on Feb. 24, 2022, both of which are incorporated by reference herein in their entireties for all purposes.

### FIELD

The present disclosure relates to the field of electronic cigarette device technologies, and more specifically, to an electromagnetic induction member, a heating device having the electromagnetic induction member, and an electronic cigarette having the heating device.

### BACKGROUND

In the related art, electronic cigarettes mainly use resistive heating and electromagnetic induction heating. The electromagnetic induction heating is receiving more attention due to advantages such as fast temperature rise, uniform heating, high precision in temperature control, and good tobacco carbonization effect.

At present, a heating device of an electronic cigarette on the market has a relatively large number of internal structural components, leading to a complex structure and production process and high manufacturing costs. In addition, because an electromagnetic induction heating coil is mostly formed by winding a solid metal wire, a thickness of a heating region of the electronic cigarette and an overall size of the electronic cigarette are relatively large, making the electronic cigarette inconvenient to carry, and reducing user experience.

### SUMMARY

A first aspect of an example of the present disclosure provides an electromagnetic induction member. The electromagnetic induction member includes a conductive layer and a support frame, the conductive layer being bonded to the support frame.

A second aspect of the present disclosure provides a heating device. The heating device includes a heating element and the electromagnetic induction member described in the first aspect. An accommodating space is formed inside the support frame, the heating element is at least partially located in the accommodating space, and a conductive layer is bonded to an outer wall of the support frame facing away from the heating element.

A third aspect of the present disclosure provides an electronic cigarette. The electronic cigarette includes a housing and the heating device described in the second aspect. The heating device is fixed inside the housing, and is configured to heat tobacco.

It should be noted that the above general description and the following detailed description are illustrative and explanatory, and are not intended to limit the present disclosure.

### BRIEF DESCRIPTION OF THE DRAWINGS

To more clearly describe the technical solutions in the embodiments of the present disclosure, the accompanying drawings required for describing the embodiments are briefly introduced below. Apparently, the accompanying drawings in the following description show some embodiments of the present disclosure, and a person skilled in the art may still derive other drawings from these accompanying drawings without creative effort.

FIG. 1 is a schematic diagram of a working principle of heating by using electromagnetic induction;

FIG. 2a is a schematic structural diagram of an electronic cigarette without tobacco inserted according to an embodiment of the present disclosure;

FIG. 2b is a schematic structural diagram of tobacco inserted into an electronic cigarette of the present disclosure from a side view angle in the embodiment shown in FIG. 2a;

FIG. 3 is a schematic structural diagram of an electronic cigarette of the present disclosure from a side view angle;

FIG. 4 is a schematic sectional structural view of the electronic cigarette of the present disclosure from a side view angle in the embodiment shown in FIG. 3;

FIG. 5 is a partial schematic sectional structural view of a heating device of the present disclosure from a side view angle in this embodiment;

FIG. 6 is a schematic structural diagram of a support frame from a side view angle in this embodiment;

FIG. 7 is a schematic partial enlarged view of a structure I of a control device in the embodiment shown in FIG. 4; and

FIG. 8 is a schematic partial enlarged view of a structure II of an electronic cigarette in the embodiment shown in FIG. 4 according to the present disclosure.

### DETAILED DESCRIPTION

For ease of understanding the present disclosure, the present disclosure is described more comprehensively below with reference to the accompanying drawings. The accompanying drawings show exemplary implementations of the present disclosure. However, the present disclosure may be implemented in many different forms, and is not limited to the implementations described in this specification. On the contrary, the implementations are provided to make understanding of the disclosed content of the present disclosure more comprehensive.

The following embodiments are described with reference to the accompanying drawings, and are used to exemplify particular embodiments that the present disclosure can be used to implement. The serial numbers for components in this specification, such as “first” and “second”, are only used to distinguish the described objects, and do not have any order or technical meaning. In the present disclosure, “connection” and “coupling” include direct and indirect connection (coupling) unless otherwise specified. The directional terms mentioned in the present disclosure, for example, “upper”, “lower”, “front”, “rear”, “left”, “right”, “inside”, “outside”, “side”, or the like are merely directions in which reference is made to the accompanying drawings. Therefore, the directional terms used are intended to better and more clearly describe and understand the present disclosure, instead of indicating or implying that the apparatus or element needs to have a specific orientation, be constructed in a specific orientation, and operate in a specific orientation. Therefore, the directional terms used cannot be construed as a limitation on the present disclosure.

In the description of the present disclosure, it should be noted that: unless otherwise explicitly specified or defined, the terms such as “install”, “connect”, and “connection” should be understood in a broad sense. For example, the connection may be a fixed connection, a detachable connection, or an integral connection; the connection may be a mechanical connection; or the connection may be a direct connection, an indirect connection through an intermediary, or internal communication between two elements. A person skilled in the art may understand specific meanings of the terms in the present disclosure according to specific situations. It should be noted that, in the description, claims, and accompanying drawings of the present disclosure, the terms “first”, “second”, or the like are intended to distinguish between different objects but do not indicate a particular order. In addition, the terms “include”, “may include”, “comprise”, or “may comprise” used in the present disclosure indicate existence of corresponding functions, operations, elements, or the like disclosed, and do not limit another one or more functions, operations, elements, or the like. In addition, the term “include” or “comprise” indicates that a corresponding feature, a number, a step, an operation, an element, a component, or a combination thereof disclosed in the description exists, and does not exclude the existence or addition of one or more other features, numbers, steps, operations, elements, components, or a combination thereof, and is intended to cover non-exclusive inclusion.

Unless otherwise defined, meanings of all technical and scientific terms used in this specification are the same as those usually understood by a person skilled in the art to which the present disclosure belongs. In this specification, terms used in the description of the present disclosure are merely intended to describe objectives of the specific implementations, but are not intended to limit the present disclosure.

Referring to FIG. 1, FIG. 1 is a schematic diagram of a working principle of heating by using electromagnetic induction. As shown in FIG. 1, when electromagnetic induction is used for heating, a metal coil 1 is usually used to be wound along a coil support 2 to form a helical heating coil la. The coil support 2 is a hollow structure. A to-be-heated portion 3 is arranged inside the coil support 2 coaxially with the coil support 2, and the to-be-heated portion 3 is a material with magnetic permeability such as metal.

When an alternating current of a specific frequency is applied to the metal coil 1, the helically wound heating coil 1a generates an alternating magnetic field 5. The to-be-heated portion 3 arranged in the alternating magnetic field 5 continuously cuts alternating magnetic lines of force 5a, and internally generates an alternating current, that is, an eddy current. The eddy current causes atoms inside the to-be-heated portion 3 to move randomly at high speed, to continuously collide and rub against each other, thereby generating heat energy. In other words, an effect of heating the to-be-heated portion 3 is achieved through electromagnetic induction. Furthermore, a heating temperature of the to-be-heated portion 3 can be controlled by controlling a frequency of the alternating current.

Based on the working principle of electromagnetic induction heating shown in FIG. 1, the electronic cigarette of the present disclosure uses an electromagnetic induction heating manner, and a corresponding induction support (that is, a support frame) is prepared by bonding a conductive layer to a plastic support. This not only simplifies a number of structural parts, but also reduces assembly and production difficulty.

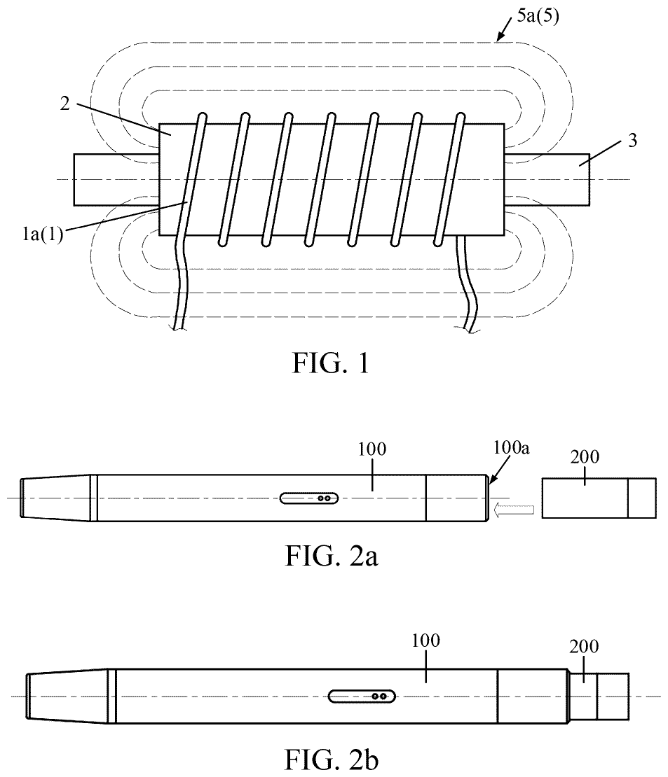

Referring to FIG. 2a and FIG. 2b, FIG. 2a is a schematic structural diagram of an electronic cigarette 100 without tobacco 200 inserted according to an embodiment of the present disclosure. FIG. 2b is a schematic structural diagram of an embodiment shown in FIG. 2a in which the tobacco 200 is inserted into an interior of the electronic cigarette 100 of the present disclosure at a side view angle. As shown in FIG. 2a, an end of the electronic cigarette 100 of the present disclosure has an insertion port 100a for allowing the tobacco 200 to be inserted into the electronic cigarette 100 of the present disclosure. The tobacco 200 may be tobacco oil, special cut tobacco (that is, a cartridge), or the like. As shown in FIG. 2b, after the tobacco 200 is inserted into the interior of the electronic cigarette 100 of the present disclosure from the insertion port 100a at the end of the electronic cigarette 100 and fixed, the electronic cigarette 100 of the present disclosure heats tobacco 200 by using electromagnetic induction.

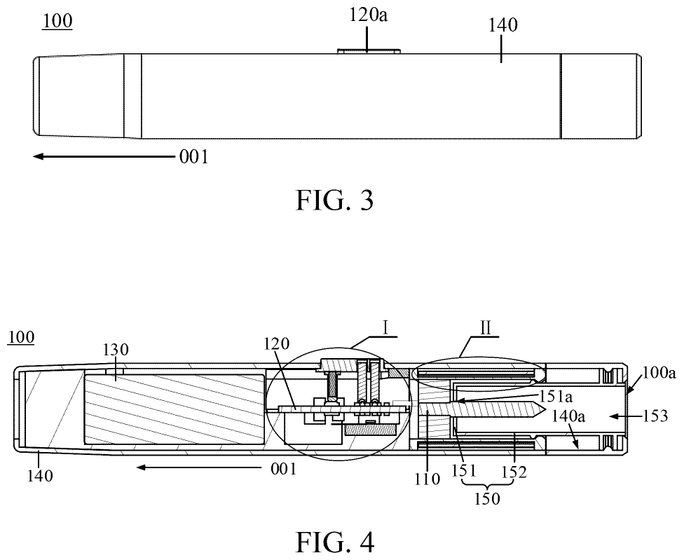

Referring to FIG. 3 and FIG. 4, FIG. 3 is a schematic structural diagram of an electronic cigarette 100 of the present disclosure from a side view angle. FIG. 4 is a schematic sectional structural view of the electronic cigarette 100 of the present disclosure from a side view angle in the embodiment shown in FIG. 3. In an embodiment of the present disclosure, the electronic cigarette 100 includes a heating device 110, a control device 120, a power supply device 130, and a housing 140. As shown in FIG. 3, a cross-sectional shape of the housing 140 is circular, a structure thereof is a hollow tubular structure, and extends in a first direction 001. The first direction 001 is an axial direction of the electronic cigarette 100. In some other embodiments of the present disclosure, the cross-sectional shape of the housing 140 may be a rectangle, an oval, or another shape.

As shown in FIG. 4, the heating device 110, the control device 120, and the power supply device 130 are all fixed inside the housing 140, and the heating device 110, the control device 120, and the power supply device 130 are connected to each other through a wire or another element (not shown in the figure) that can implement an electrical connection function, so that the control device 120 can control the coordinated operation of the components inside the electronic cigarette 100 of the present disclosure. In addition, the power supply device 130 can provide electrical energy to components inside the electronic cigarette 100 of the present disclosure, so that the electronic cigarette 100 can work normally.

In an embodiment of the present disclosure, the heating device 110 may be arranged at an end close to the insertion port 100a, so that when the tobacco 200 is inserted into the interior of the electronic cigarette 100 of the present disclosure from the insertion port 100a, the tobacco 200 inserted into the interior of the electronic cigarette 100 can be heated by the heating device 110.

In an embodiment of the present disclosure, the power supply device 130 may be a storage battery, a lithium manganate battery, or the like.

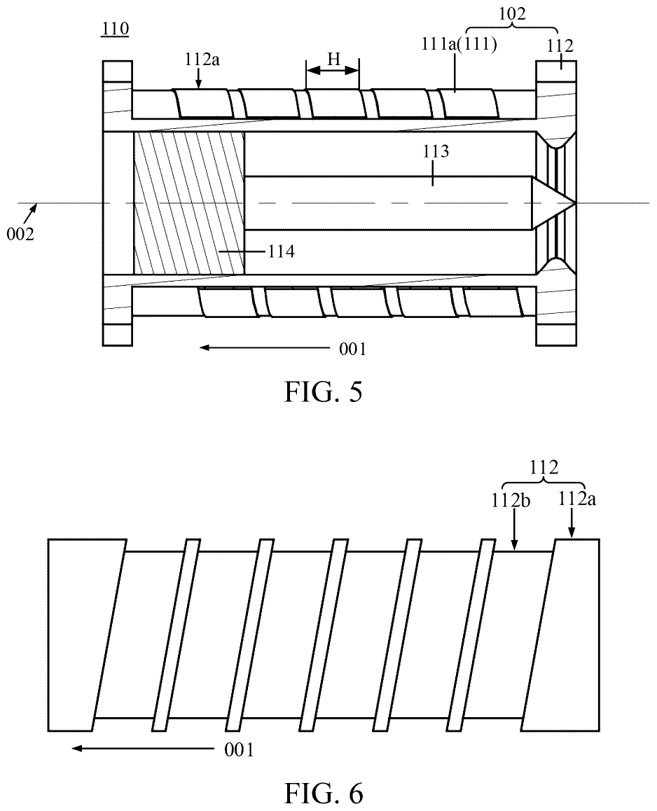

In an embodiment, the electronic cigarette 100 of the present disclosure further includes a tobacco container 150, and the tobacco container 150 is configured to place the tobacco 200. Specifically, as shown in FIG. 4, the tobacco container 150 is arranged inside a support frame 112 (as shown in FIG. 5) of the heating device 110, and is coaxially arranged with the housing 140. In other words, the tobacco container 150 extends in the first direction 001, and the tobacco container 150 is movable relative to the support frame 112 in the first direction 001. A material of the tobacco container 150 is a food-grade plastic material. For example, the material of the tobacco container 150 may be a semi-crystalline aromatic plastic engineering plastic (polyetheretherketone (PEEK)) material.

Furthermore, the tobacco container 150 may be a hollow tubular structure as a whole, including a bottom wall 151 and a side wall 152. The bottom wall 151 and the side wall 152 together form an accommodating cavity 153 having a first opening (not shown in the figure). The first opening is arranged opposite to the bottom wall 151, that is, the first opening and the bottom wall 151 are respectively two opposing ends of the accommodating cavity 153. The accommodating cavity 153 is a cavity with an opening at one end thereof. The first opening is close to an end of the insertion port 100a of the electronic cigarette 100, so that the tobacco 200 can inserted from the first opening into the tobacco container 150 through the insertion port 100a. The accommodating cavity 153 is configured to fix and take out the tobacco 200, that is, when the tobacco 200 is inserted into the accommodating cavity 153, the tobacco container 150 can fix the tobacco 200, and when the tobacco 200 needs to be taken out from an interior of the accommodating cavity 153, the tobacco container 150 can take out the tobacco 200 as a whole, thereby preventing the tobacco 200 from remaining the electronic cigarette 100.

In an embodiment of the present disclosure, the bottom wall 151 has a through hole 151a. A cross-sectional shape of the through hole 151a matches a cross-sectional shape of a heating element 113 (as shown in FIG. 5) in the heating device 110 of the present disclosure, so that the heating element 113 can extend into the tobacco container 150 through the through hole 151a, thereby heating the tobacco 200.

Referring to FIG. 5, FIG. 5 is a partial schematic sectional structural view of a heating device 100 of the present disclosure from a side view angle in this embodiment. The heating device 110 of the present disclosure includes an electromagnetic induction member 102 and a heating element 113. The electromagnetic induction member 102 includes a conductive layer 111 and a support frame 112. As shown in FIG. 5, the conductive layer 111 is bonded to the support frame 112, so that the conductive layer 111 and the support frame 112 are formed into an indivisible integral structure, to avoid formation of a gap between the conductive layer 111 and the support frame 112, thereby reducing an overall size of the electromagnetic induction member 102 and simplifying a structure of the electromagnetic induction member 102. Furthermore, as shown in FIG. 5, the support frame 112 is sheathed inside the housing 140, and extends in the first direction 001. In the embodiment shown in FIG. 5, the support frame 112 is a hollow tubular structure as a whole, and an outer diameter of the support frame 112 matches an inner diameter of the housing 140, so that the support frame 112 is fixed relative to the housing 140, that is, the support frame 112 is mounted and fixed in the housing 140. In some other embodiments of the present disclosure, the cross-sectional shape of the support frame 112 may be a rectangle, an oval, or the like.

In an embodiment of the present disclosure, an accommodating space is formed inside the support frame 112, the heating element 113 is at least partially located in the accommodating space, and the conductive layer 111 is bonded to an outer wall 112a of the support frame 112 facing away from the heating element 113. The bonding includes, but is not limited to: connection relationships such as exact fit, fusion, and at least partial embedding. In other words, the conductive layer 111 may be arranged on the outer wall 112a of the support frame 112 facing away from the heating element 113 by a connection manner such as exact fit, fusion, or at least partial embedding, so that there is no gap between the conductive layer 111 and the outer wall 112a of the heating element 113.

In an embodiment of the present disclosure, the support frame 112 may be made of a high-temperature resistant plastic material such as a PEEK material or a polyimide (PI) material.

Furthermore, the conductive layer 111 may be a long strip-shaped structure as a whole, and is arranged around the outer wall 112a of the support frame 112. Specifically, as shown in FIG. 5, a layer of a conductive metal material is helically deposited around a central axis 002 of the support frame 112, to form a conductive layer 111 having a helical structure extending in the first direction 001 on the outer wall 112a. By making the conductive layer 111 be in a shape of a long strip, and making the conductive layer 111 helically extend around the outer wall 112a of the support frame 112 in the first direction 001, the alternating magnetic field can be generated after the alternating current is applied to the conductive layer 111. The conductive layer 111 is deposited on the outer wall 112a of the support frame 112 facing away from the heating element 113. The deposition is that some atoms, molecules, ions, and the like of the conductive layer 111 and some atoms, molecules, ions, and the like of the outer wall 112a fuse with each other, so that the conductive layer 111 is partially fused or exactly fitting with the outer wall 112a, so that the conductive layer 111 and the support frame 112 are seamlessly connected and formed as an indivisible body.

In an embodiment of the present disclosure, a thickness of the conductive layer 111 ranges from 0 to 0.2 mm, for example, 0.02 mm, 0.08 mm, 0.1 mm, 0.15 mm, 0.18 mm, 0.2 mm, or another value. Optionally, the conductive layer 111 may be deposited on the outer wall 112a by electroplating, chemical plating, a laser direct structuring (LDS) process, a physical vapor deposition (PVD) process, a chemical vapor deposition (CVD) technology, or the like. A material of the conductive layer 111 may be a metal with good conductivity, such as copper, nickel, silver, gold, or zinc.

The conductive layer 111 is deposited on the outer wall 112a by physical vapor deposition, so that the conductive layer 111 is bonded to the outer wall 112a of the support frame 112. The conductive layer 111 is deposited on the outer wall 112a by chemical vapor deposition, so that the conductive layer 111 is bonded to the outer wall 112a of the support frame 112.

In an embodiment, the conductive layer 111 is a plating layer. In other words, in this embodiment, the conductive layer 111 may further be bonded to the outer wall 112a by electroplating or chemical plating, to be integrally formed with the support frame 112.

In an embodiment, the conductive layer 111 is formed on the support frame 112.

In this embodiment, the conductive layer 111 is bonded to the outer wall 112a by laser direct structuring, to be further integrally formed with the support frame 112.

In an embodiment, the conductive layer 111 is in a shape of long strips with equal width.

In this embodiment, by making the conductive layer 111 be in a shape of long strips with equal width, a uniform alternating magnetic field can be formed after the alternating current is applied to the conductive layer.

As shown in FIG. 5, the conductive layer 111 deposited on the outer wall 112aincludes multiple turns of a helical coil 111a. Each turn of the helical coil 111a has a width H. In an embodiment of the present disclosure, both a number of turns of the conductive layer 111 and the width H of each turn of the helical coil 111a may be adjusted based on actual requirements. In this embodiment, the conductive layer 111 is formed by depositing a layer of a conductive metal material on the support frame 112, the connection reliability between the conductive layer 111 and the support frame 112 can be improved, and a structure of the support frame 112 is simplified. In addition, an overall external size of the heating device 110 of the present disclosure can be reduced, thereby reducing the design space of the electronic cigarette 100 occupied by the heating device 110 of the present disclosure, and improving user experience.

Furthermore, as shown in FIG. 5, a fixed portion 114 is fixed to an end of an interior of the support frame 112, that is, the fixed portion 114 is fixed to an end of the accommodating space. The fixed portion 114 is configured to fix the heating element 113, so that the heating element 113 is fixed relative to the support frame 112, and the heating element 113 and the support frame 112 are coaxially arranged. In an embodiment of the present disclosure, a material of the fixed portion 114 may be a high-temperature plastic material, ceramic, or the like, and a material of the heating element 113 is a material with high magnetic permeability such as iron. The heating element 113 may be detachably connected to the fixed portion 114 through a thread, to facilitate replacement of the heating element 113. It should be noted that, the material with high magnetic permeability generally refers to a material that can be magnetized by magnetic lines of force, that is, can be attracted by a magnet, for example, carbon steel or stainless iron.

Specifically, in the embodiment shown in FIG. 5, the heating element 113 may be a needle-like structure having a tip end, and the tip end faces an end of the accommodating space. In other words, the tip end points toward an end of the insertion port 100a, so that the heating element 113 is inserted into the tobacco 200, to create an effect of heating the tobacco 200 by the heating element 113. In this embodiment, the heating element 113 of a needle-like structure can increase a contact area between the heating element 113 and the tobacco 200 while not affecting the insertion of the tobacco 200, thereby improving heating efficiency and heating uniformity of the tobacco 200.

In some other embodiments of the present disclosure, the heating element 113 may alternatively be a sheet-like structure, a tubular structure, a columnar structure, or another structure.

Since the conductive layer 111 is a coil helically extending around the heating element 113, after an alternating current of a specific frequency is applied to the conductive layer 111, the conductive layer 111 generates an alternating magnetic field (not shown in the figure) that surrounds the heating element 113. When a magnetic field generated by the conductive layer 111 continuously changes, a phenomenon in which the heating element 113 continuously cuts magnetic lines of force (not shown in the figure) is formed, so that an alternating current, that is, an eddy current, is continuously generated inside the heating element 113. The eddy current generated inside the heating element 113 causes atoms inside the heating element 113 to move irregularly at high speed and continuously collide and rub against each other, thereby generating heat energy. The heat energy generated by the heating element 113 can heat the tobacco 200.

In this embodiment, after the heating element 113 is heated to a predetermined temperature, the tobacco 200 arranged around the heating element 113 is heated and baked. The predetermined temperature usually ranges from 250 to 400° C.

In an embodiment, referring to FIG. 6, FIG. 6 is a schematic structural diagram of a support frame 112 from a side view angle in this embodiment. In the embodiment shown in FIG. 6, the outer wall 112a of the support frame 112 is provided with a groove 112b. The groove 112b helically extends around the outer wall 112a of the support frame 112 in the first direction 001. An opening direction of the groove 112b faces away from the heating element 113. In this embodiment, a conductive layer 111 (as shown in FIG. 5) that helically extends around the outer wall 112a of the support frame 112 in the first direction 001 can be formed by depositing a conductive metal material in the groove 112b. In addition, the outer wall 112a of the support frame 112 is provided with the groove 112b, so that the conductive layer 111 can be embedded into the support frame 112, thereby improving connection reliability between the conductive layer 111 and the support frame 112. In addition, an external size of the heating device 110 can be further reduced.

In an embodiment, a surface roughness of the outer wall 112a of the support frame 112 is increased to further improve the connection reliability between the conductive layer 111 and the support frame 112. Specifically, in this embodiment, a frosted layer (not shown in the figure) is fixed on the outer wall 112a of the support frame 112, that is, the frosted layer is arranged between the conductive layer 111 and the outer wall 112a. A surface roughness of the frosted layer is greater than 0.8 um. In some other embodiments of the present disclosure, multiple convex points may be further provided on the outer wall 112a to increase the surface roughness of the outer wall 112a.

In this embodiment, the surface roughness of the outer wall 112a of the support frame 112 is increased, so that the connection reliability between the conductive layer 111 and the support frame 112 can be further improved.

In the related art, when electromagnetic induction heating is used, a conductive coil is usually wound along a coil support to form a helical heating coil. Before the conductive coil is wound on the coil support, the conductive coil needs to be preprocessed, for example, a process such as spraying insulation varnish and immersing glue, so that complexity of a production work of the heating device is increased.

In addition, structural complexity of the coil support increases, and manufacturing costs increase. Further, to ensure heating efficiency and heating stability, an existing heating device usually uses a conductive coil with a large diameter to be wound on a coil support. The conductive coil is detachably connected to the coil support, and a specific gap exists between the conductive coil and the coil support. As a result, an overall size of the heating device increases, an occupation space of the heating device inside the electronic cigarette is increased, an overall external size of the electronic cigarette is increased, and user experience is reduced. In the related art, an electronic cigarette in which the conductive coil is wound on the coil support for heating is used, and an external machine diameter of the electronic cigarette is generally greater than 18 mm.

However, in the heating device 110 of the present disclosure, by using the electromagnetic induction member 102 of the present disclosure, the conductive layer 111 is directly formed on the outer wall 112a of the support frame 112 by depositing a layer of a metal material, so that the conductive layer 111 and the support frame 112 are formed into an integral structure, which can improve the connection reliability between the conductive layer 111 and the support frame 112. Furthermore, by using the electromagnetic induction member 102 of the present disclosure, the internal structure of the heating device of the present disclosure can be simplified, assembly efficiency can be improved, and production costs can be reduced. Furthermore, the conductive layer 111 is formed by direct deposition. In this way, process steps of preprocessing the conductive coil are reduced, and a manufacturing process procedure of the heating device 110 of the present disclosure is simplified. In addition, a number of structures are simplified, and assembly and production difficulties are also reduced. In addition, the conductive layer 111 and the support frame 112 are in an integral structure, which can avoid a gap between the conductive layer 111 and the support frame 112, thereby reducing an external volume of the heating device 110 of the present disclosure. Furthermore, a thickness dimension of the conductive layer 111 is small, which can further reduce an overall external size of the heating device 110 of the present disclosure, and reduce space occupied by the heating device 110 of the present disclosure in the electronic cigarette 100 of the present disclosure. Furthermore, the space occupied by the heating device 110 in the electronic cigarette 100 of the present disclosure is reduced, so that an external machine size of the electronic cigarette 100 of the present disclosure can be reduced. That is, an external machine diameter of the electronic cigarette 100 of the present disclosure is reduced to 16.5 mm and below, thereby improving usage experience of a user.

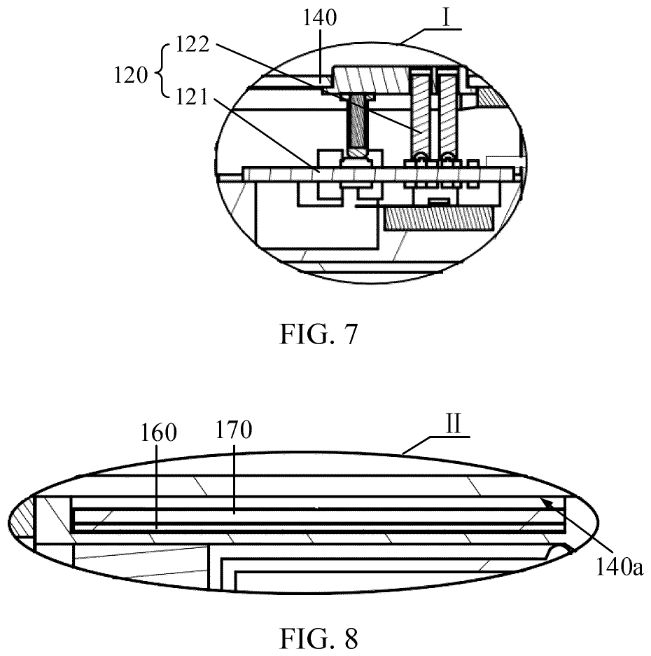

In an embodiment, referring to FIG. 7, FIG. 7 is a schematic partial enlarged view of a structure I of a control device 120 in the embodiment shown in FIG. 4. In the embodiment shown in FIG. 7, the control device 120 includes a main board component 121 and an interaction element 122. Specifically, as shown in FIG. 7, the main board component 121 is fixed inside the housing 140. The main board component 121 may be provided with elements such as a central processing unit (CPU), or a temperature control switch. These elements may output different control signals to the user based on different working states of the electronic cigarette, or control a working state of the electronic cigarette based on instructions inputted by the user. The interaction element 122 is electrically connected to the main board component 121, and the interaction element 122 is partially exposed from the housing 140 to facilitate user operation. The interaction element 122 is configured to output different working signals to the user or receive the instructions inputted by the user in real time to implement interaction between the user and the electronic cigarette, so that the user can conveniently and quickly control the electronic cigarette 100.

In an embodiment of the present disclosure, the main board component 121 may be a printed circuit board (PCB), or the like. The interaction element 122 includes, but is not limited to, an element such as a key, an indicator light, and a vibration motor.

In an embodiment, the power supply device 130 further includes a charging interface (not shown in the figure). The charging interface is configured to provide electrical energy to the power supply device 130, so that the power supply device 130 stores the electrical energy. In this embodiment, the power supply device 130 may be an internal battery or an internal battery pack. The charging interface may be an external portable power supply compartment. The external portable power supply compartment has a larger electrical energy capacity than the internal battery, and can provide a longer battery life for a product, so that the user heats a tobacco product for multiple times.

In an embodiment, referring to FIG. 8, FIG. 8 is a schematic partial enlarged view of a structure II of an electronic cigarette 100 of the present disclosure in the embodiment shown in FIG. 4. In this embodiment, the electronic cigarette 100 of the present disclosure further includes a thermal insulating layer 160. As shown in FIG. 4, the thermal insulating layer 160 is arranged between the heating device 110 and an inner wall 140a of the housing 140. In other words, the thermal insulating layer 160 completely covers the conductive layer 111 of the heating device 110, and is configured to prevent heat generated by the heating device 110 from being diffused outward and being lost when the heating device 110 heats the tobacco.

In an embodiment of the present disclosure, the thermal insulating layer 160 may be a thermal insulation foam layer, an aerogel thermal insulating layer, a vacuum thermal insulating tube layer, a thermal insulating engineering plastic layer, or the like. In other words, the thermal insulating layer 160 is provided to improve heating efficiency of the heating device 110 of the present disclosure. In addition, a temperature of a surface of the housing 140 can be effectively reduced, thereby improving user experience.

In an embodiment, the electronic cigarette 100 of the present disclosure further includes a shielding member 170 with high magnetic permeability. The shielding member 170 is arranged between the thermal insulating layer 160 and the inner wall 140a of the housing 140, and is configured to minimize an electromagnetic field outside the electronic cigarette 100 of the present disclosure. In the embodiment shown in FIG. 8, the shielding member 170 is arranged between the thermal insulating layer 160 and the inner wall 140a of the housing 140, that is, the shielding member 170 completely covers the thermal insulating layer 160.

In an embodiment of the present disclosure, the shielding member 170 may be an inner coating layer coated on the inner wall 140a of the housing 140, or may be a sheet material arranged between the heating device 110 and the housing 140.

Because the electronic cigarette 100 of the present disclosure uses the heating device 110 of the present disclosure, the electronic cigarette 100 of the present disclosure obtains all beneficial effects that the heating device 110 of the present disclosure may have. Specifically, the heating device 110 of the present disclosure forms the conductive layer 111 by depositing the layer of the conductive metal material on the support frame 112, the external size of the heating device 110 of the present disclosure can be reduced, thereby reducing the space occupied by the heating device 110 inside the electronic cigarette 100. In addition, the heating device 110 of the present disclosure has a relatively small number of internal structural components, a simplified structure, and has high assembly efficiency and low production costs. Further, the electronic cigarette 100 of the present disclosure can be more compact in structural design, and has a relatively small external size than the electronic cigarette in the related art, thereby improving usage experience of the user.

It should be understood that, the terms “first”, “second”, or the like are used for descriptive purposes only and should not be construed as indicating or implying relative importance or implicitly indicating the number of the indicated technical features. Therefore, features limited by “first” and “second” may explicitly indicate or implicitly include one or more features. In descriptions of implementations of the present disclosure, “multiple” means two or more, unless otherwise defined clearly and specifically.

In the descriptions of this specification, descriptions of reference terms such as “one implementation”, “some implementations”, “exemplary implementation”, “example”, “specific example” or “some examples” mean that specific characteristics, structures, materials, or features described with reference to the implementation or example are included in at least one implementation or example of the present disclosure. In this specification, schematic descriptions of the foregoing terms are not necessarily with respect to the same implementation or example. In addition, the described specific characteristics, structures, materials, or features may be combined in a proper manner in any one or more implementations or examples.

It should be understood that, the application of the present disclosure is not limited to the foregoing examples. A person skilled in the art may make improvements or modifications according to the foregoing description, and all of the improvements and modifications should all fall within the protection scope of the attached claims of the present disclosure. A person skilled in the art may understand all or some processes of the foregoing embodiments, and equivalent modifications made according to the claims of the present disclosure shall still fall within the scope of the present disclosure.

What is claimed is:

1. An electromagnetic induction member, comprising a conductive layer and a support frame, the conductive layer being bonded to the support frame.

2. The electromagnetic induction member according to claim 1, wherein the conductive layer and the support frame are seamlessly connected.

3. The electromagnetic induction member according to claim 1, wherein the conductive layer and the support frame are formed into an indivisible integral structure.

4. The electromagnetic induction member according to claim 1, wherein the conductive layer is in a shape of a long strip, and the conductive layer extends helically around an outer wall of the support frame in a first direction, the first direction being an axial direction of the support frame.

5. The electromagnetic induction member according to claim 1, wherein the conductive layer is in a shape of long strips with equal width.

6. The electromagnetic induction member according to claim 1, wherein the conductive layer is deposited on the support frame.

7. The electromagnetic induction member according to claim 1, wherein the conductive layer is a plating layer.

8. The electromagnetic induction member according to claim 1, wherein the conductive layer is formed on the support frame.

9. The electromagnetic induction member according to claim 1, wherein a thickness dimension of the conductive layer ranges from 0 to 0.2 mm.

10. The electromagnetic induction member according to claim 1, wherein the support frame further comprises a frosted layer, and the conductive layer is bonded to the frosted layer, wherein a surface roughness of the frosted layer is greater than 0.8 um.

11. The electromagnetic induction member according to claim 1, wherein the support frame is provided with a groove, the groove extending helically around an outer wall of the support frame in an axial direction of the support frame, and the conductive layer being arranged in the groove.

12. A heating device, comprising:
an electromagnetic induction member, comprising:
a support frame, which forms an accommodating space inside; and
a conductive layer, bonded to the support frame;
a heating element, at least partially located in the accommodating space, and the conductive layer being bonded to an outer wall of the support frame facing away from the heating element.

13. The heating device according to claim 12, wherein the heating element is any one of a needle-like structure, a sheet-like structure, a tubular structure, or a columnar structure.

14. The heating device according to claim 12, further comprising a fixed portion, the fixed portion being fixed to an end of the accommodating space, and the heating element being fixed to the fixed portion and coaxially arranged with the support frame.

15. An electronic cigarette, comprising:
a housing; and
a heating device, fixed inside the housing and configured to heat tobacco, and comprises:
an electromagnetic induction member, comprising:
a support frame, which forms an accommodating space inside; and
a conductive layer, bonded to the support frame;
a heating element, at least partially located in the accommodating space, and the conductive layer being bonded to an outer wall of the support frame facing away from the heating element.

16. The electronic cigarette according to claim 15, further comprising a tobacco container of a tubular structure, the tobacco container being sheathed in the support frame, and being movable relative to the support frame in a first direction, and the tobacco being arranged in the tobacco container.

17. The electronic cigarette according to claim 16, wherein the tobacco container comprises a bottom wall and a side wall, the side wall being arranged around a peripheral side of the bottom wall and forming an accommodating cavity, the tobacco being arranged in the accommodating cavity, the bottom wall being provided with a through hole, and the heating element extending into an interior of the tobacco container through the through hole to heat the tobacco.

18. The electronic cigarette according to claim 15, further comprising a thermal insulating layer, the thermal insulating layer being arranged between the heating device and the housing.

19. The electronic cigarette according to claim 15, further comprising a shielding member, the shielding member being arranged between the heating device and the housing.

20. The electronic cigarette according to claim 15, further comprising a control device and a power supply device, the control device being arranged inside the housing, the control device being electrically connected to the heating device to enable components of the electronic cigarette work in cooperation, and the power supply device being arranged inside the housing, and being configured to provide electrical energy to the components of the electronic cigarette.
